(19) United States
(12) Patent Application Publication
(10) Pub. No.: US 2013/0325624 A1
(43) Pub. Date: Dec. 5, 2013

(54) ACTIVE AUDIENCE CONTROL

(71) Applicants: Aidan Thomas Cardella, Wellesley, MA (US); Peter Allen Bishop, Norfolk, MA (US)

(72) Inventors: Aidan Thomas Cardella, Wellesley, MA (US); Peter Allen Bishop, Norfolk, MA (US)

(73) Assignee: ChoiceStream, Inc., Boston, MA (US)

(21) Appl. No.: 13/484,927

(22) Filed: May 31, 2012

(51) Int. Cl. G06Q 30/02

(52) U.S. Cl. 705/14.66

(57) ABSTRACT

An active control of advertising is enhanced through the use of solicited information to gain knowledge about a desired population of users. In some examples, this knowledge about users provides a self-identification of target users, and this self-identification is used to select further users with similar characteristics, who would also be likely to self-identify themselves as target users.

### BACKGROUND

This invention relates to active control of online advertising, and more particularly to automated optimization based on advertising embedded solicitations from users.

Current online advertising is often based on an auction model in which, when an opportunity for presentation of advertising content to an end user is available, information about the end user (or more particularly, about the particular computer or instance of a browser application being used by the user using “cookie” based techniques) as well as information about the context of the advertising opportunity (or “impression”), for example, the domain, website, time of day, time zone, geo-location, creative size, etc., is made available to an advertising party (i.e., the party managing to placement of advertisements for one or more advertising or marketing campaigns) that may want to use the opportunity, and based on the end user and context information that advertising party may make an offer (e.g., a “bid”) to acquire that advertising opportunity.

After an advertisement is presented to the user in an advertising opportunity, some tracking of the end user's behavior after the party's ad is presented in that opportunity may be available to that party, for example, by tracking the subsequent online locations (e.g., web pages) that the end user navigates. For example, the advertising party may acquire unsolicited data that characterizes whether the advertisement resulted in the end user seeking further information related to the advertisement (e.g., by selecting/“clicking” on the advertisement) or in the user performing purchase-related actions (e.g., filling a shopping cart, making a purchase, etc.). In some systems, such unsolicited data may be used to refine an advertising party's knowledge about an end user. This refined information may then be used to inform further bids by the advertising party when that end user, or other similar end users, are again presented as advertising opportunities.

In some current approaches, an advertising campaign may be targeted to users defined by particular demographic characteristics. Often, these demographics are chosen manually. Online survey techniques are available to evaluate the effectiveness of an advertising campaign. For example the targeted demographics may be manually modified to improve the effectiveness of a campaign when the survey information indicates a lack of effectiveness. In some current approaches, in addition to or instead of use of demographic information about users for targeting advertisements, prior online interaction, which can include providing information in search fields or online forms, may be used as the basis for defining the demographic for targeting the advertising campaign.

### SUMMARY

There is a need to improve management of advertising campaigns, and in particular, to better define target users for presentation of one or more advertisements of an advertising campaign. For example, a manual step of selecting characteristics (e.g., demographic characteristics) for an advertisement can be error prone and/or difficult, particularly when there is no definitive correspondence of available user characteristics and users desired to be targeted. Surveys that assess effectiveness of campaigns may not provide feedback in a manner that can be used to adapt a campaign quickly enough and/or in an automated manner.

In one general aspect, an active control of advertising is enhanced through the use of solicited information to gain knowledge about an end user and similar end users. In some examples, this knowledge about users provides a self-identification of target users, and this self-identification is used to select further users with similar characteristics, who would also be likely to self-identify themselves as target users.

In some examples, the solicitation makes use of a presentation of an advertisement to a user to also present a solicitation of a response from the user such that the solicitation is embedded within an advertisement itself. An example of such a solicitation is a poll requesting that the end user choose from a set of multiple choice answers to a questions (e.g., by selecting one of multiple response buttons with a pointing device on the user's display). An example of a poll includes presentation in an advertisement for a coffee shop “Do you stop coffee on the way to work (a) seldom, (b) once a month, (c) once a week, (d) daily”, with a response representing one of the four options. In some examples, a solicited response can be used to determine an affinity to a brand's product or message.

In some examples, solicited response data that is obtained from an explicit solicitation is used in conjunction with unsolicited data, for example, characterizing navigation and/or purchase-related actions. In other examples, separate processing of solicited response data and unsolicited data is performed by the advertising control system.

In some examples, solicited response data is used as a characteristic of a user. For example, there may be a set of possible survey questions and users that select a particular answer to a particular question are treated as sharing a common characteristic, for example, in the same way that the users may share membership in a demographic group or registration status at a particular web site. Similarly, lack of a response to a solicitation may indicate a characteristic of the user. Such characteristics may then be used as a basis for determining how or whether to take advantage of (e.g., determine bid values for) future advertising opportunities.

In some examples, the solicited response data represents a user's own characterization, for example, as a member of a demographic group, or as a user of a product or a participant of a commercial or social activity.

In some examples, selection of solicitation content for presentation to a user may be influenced in the automated system according to a value of potential responses to the solicitation by the user. For example, a particular user that has previously answered a poll question may not have that same poll presented repeatedly. Similarly, a user that is similar in many ways to a group for whom a poll response is predictable may also not have that poll presented.

In another example, in general, a method for computer implemented online advertising control includes maintaining data characterizing a plurality of users. That data includes data representing or otherwise being based on responses to solicitations presented in advertising that is presented to the users. A decision of whether and/or how to take advantage of an opportunity to present advertising associated with a further user is determined according to the data representing the responses to solicitations presented to the prior users.

Groupings of users may be identified according to the responses to the solicitations, and the selecting of the advertising then makes use of the identified grouping.

User tracking data (e.g., regression coefficients) may be determined to relate the data characterizing the plurality of users and values of advertising opportunities. Selecting the advertising is then performed according to the tracking data.

In another aspect, in general, computer implemented control of electronic advertising results in instances of one or more electronic advertisements to be presented to users at user devices, for example, via web browser applications executing at user computers. At least some of the instances of advertisements include embedded solicitations for information from the users to whom the advertisements are presented. Responses provided by a first set of the users (e.g., by a subset that actually respond to the solicitations) at the user device are received in response to presentations of the embedded solicitations. The causing of the advertisements to be presented includes automatically matching of the one or more advertisements and a second set of users (e.g., subsequent users after the responses are received) using a computer implemented system according to the received responses provided by the first set of users.

Matching advertisements and users should be understood in the broad sense of determining one or more times a correspondence between one or more advertisements and one or more users, including but not limited to determining which of a set of users correspond closely enough to an advertisement and determining which if any of a set of advertisements correspond to a particular user.

Aspects can include one or more of the following features.

Automatically matching the advertisements and users includes determining a value for each of a plurality of opportunities to present advertisements to users, where each opportunity being related to an advertisement and a user. Each advertising opportunity may be further related to a context for presenting the advertisement to the user. The context can include, without limitation, a temporal context (e.g., time of day), a web site on which the advertisement is being presented, a navigation history that lead to a web page, and a frequency of presentation or a time since last presentation of the ad to the user.

Causing the advertisements to be presented includes participating (e.g., bidding) in an electronic advertising exchange according to the determined values for the opportunities.

Matching the advertisements and users includes identifying users for presentation of an advertisement.

The embedded solicitations comprise embedded polls, and the responses comprise user responses to poll questions.

Presentations of the advertisements include visual integration of the polls in creative content of the advertisements.

Data characterizing the users is maintained to include data representing the responses to the embedded solicitations presented to the first set of users.

Automatically matching the users and advertisements according to the received responses includes (a) valuing (e.g., determining scores for) a first user for potential presentation of an advertisement and/or (b) selecting advertisements for presentation in an advertising opportunity associated with a first user according to the data representing the solicitations presented to the plurality of users.

The maintained data is used to characterize a target group of users selected according to responses to the embedded solicitations by those users.

Automatically matching according to the received responses comprises identifying the second set of the users using at least determined characteristics of a subset of the first set of the users selected according to responses to the embedded solicitations.

Automatically matching according to the received responses comprises valuing opportunities according to similarity of users' characteristics of those opportunities to characteristics of a subset of the first set of the users selected according to responses to the embedded solicitations.

Automatically matching of instance of advertisements and users comprises optimizing data characterizing a group of target users for presentation of an advertisement according to characteristics of a subset of the first set of the users selected according to responses to the embedded solicitations to achieve an objective defined in terms of the solicitations.

Presentations of the advertisements comprise solicitations that are visually integrated with advertising content of the advertisements.

Causing presentations of the advertisements comprises causing, for each instance of an advertisement, delivery of an integrated data unit comprising data representing the solicitation for that advertisement and data representing advertising content for visually integrated presentation. The integrated data unit may further comprise content for conditional presentation according to user input. In some examples, the integrated data using comprises a Flash Media file or data structure.

Causing presentations of the advertisements comprises causing, for each instance of an advertisement, delivery of a data unit comprising a reference to an external source for data representing the solicitation for that advertisement for presentation in conjunction with advertising content of the advertisement.

In another aspect, in general, software tangibly embodied on a computer-readable medium comprises instructions for causing a data processing system to perform the steps of any of the methods specified above.

In another aspect, in general, a data processing system is configured to perform the steps of any of the methods specified above.

Advantages of one or more aspects include improving targeting of an advertising campaign as a result of the automated feedback based optimization. Other advantages can include an ability to target a group of users without having to be able to manually characterize their characteristics. Self-identification by a subset of a target population is effectively extended to yield a characterization of the larger target population of users for an advertising campaign.

Other features and advantages of the invention are apparent from the following description, and from the claims.

### DESCRIPTION OF DRAWINGS

FIG. 1 is a block diagram of an online advertising system.

FIG. 2 is web page that includes an advertisement with an embedded solicitation.

### DESCRIPTION

An embodiment of an advertising control system actively controls online advertising for presentation at user computers (understanding that “computers” include various computing devices can including, without limitation, desktop and mobile computers, smartphones, tablet computers, media presentation devices, etc.). This embodiment is described in the context of an auction-based advertising system, but it should be recognized that the auction aspect is not essential. Generally, the computer-implemented system (e.g., at a centralized server computing system) repeatedly evaluates a value of an opportunity to present an advertisement to a user, and uses that evaluated value to bid for the opportunity in determining how or whether to take advantage of that opportunity (e.g., to select whether to and/or how much to bid for the advertising opportunity). An example of such opportunities includes presentation of a banner advertisement on a presentation of a web page in a user's browser (which may identify the user by certain cookies stored in it from previous browsing by that user). It should be understood that the approaches and systems described in this document are applicable more widely to other or combinations of electronic advertising environments, including for example, presentation of advertisements in video-on-demand and in electronic advertising panels.

A goal of the control system is to present the advertisements for an advertising campaign to a desirable group of users. In at least some contexts of this system, a desirable group of users is a group of users that have characteristics consistent with users who self-identify themselves as having certain target characteristics through providing responses to solicitations in the advertisements. An example of such a self-identified group is a group of users that answer “I drink coffee daily” in a poll related to coffee preferences presented in an advertisement for a coffee chain. Therefore, there can be less (if any) reliance on manually predefined demographic or other characteristics to define the target group of users. Rather, the system is configured to automatically adapt a characterization of desirable users to that of the self-identifying users, thereby optimizing the effectiveness of the advertising campaign by bidding more often and/or with higher bids in opportunities with matching users. Such optimization can provide an advantage of not requiring as much or any human insight in specifying a target audience, and can provide a degree of tracking of a time-changing characteristics, for example, over a span of time in which a brand awareness may change.

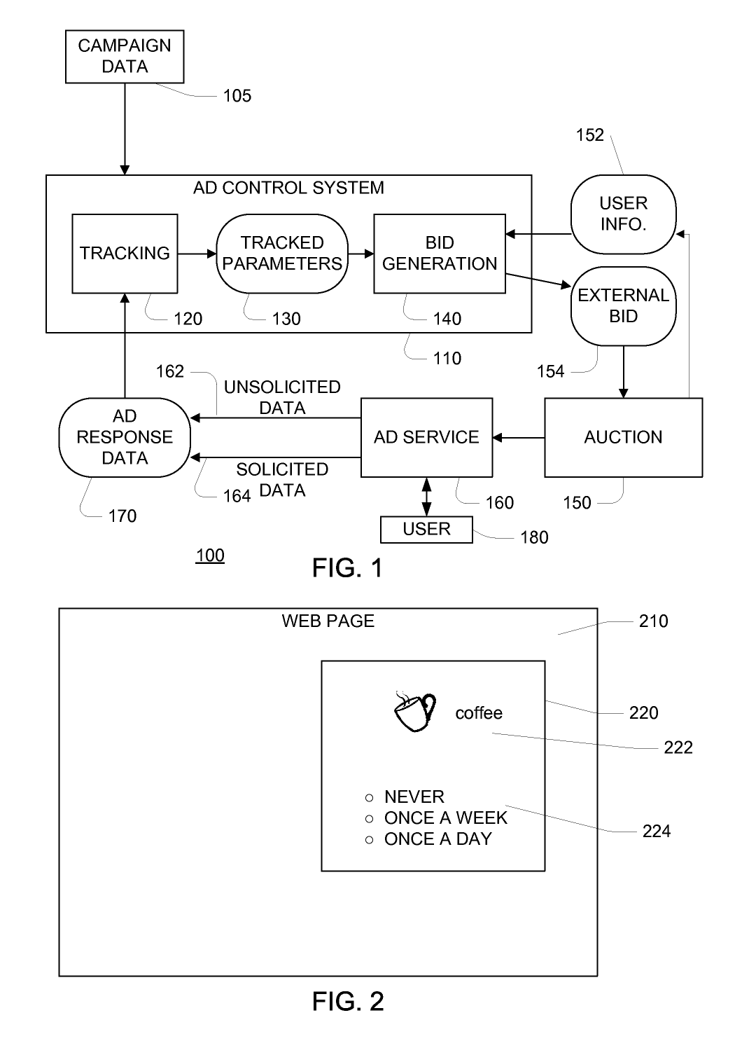

Referring to FIG. 1, an example of an online advertising system 100 include campaign data 105 that is used by an active advertising control system 110 to identify and/or score advertising opportunities to present the advertising to users 180. The active control system 110 includes a tracking component 120, which generally determines parameters 130 (e.g., associated with users, and/or relating users parameters to value or utility) that permit assessment of the value of particular advertising opportunities for various campaigns, and adjusts (e.g., estimates, tracks, or otherwise computes) the tracking parameters 130 based on data 170 receive as a result of presentation of advertisements. As introduced above, these tracking parameters 130 can be used to characterize a desirable target group of users based at least in part on solicited data 164 received in response to prior presentations of advertisements.

As outlined above, when an advertising opportunity is available to present an ad to a particular user 180, user information 152 is made available from an auction component 150. This user information, generally in conjunction with other correlated information available to the advertising system 110, is used by a bid generator 140. Generally, the bid generator combines the tracked parameters 130 and directly and indirectly obtained user information to compute bid values. In some implementations when there are multiple campaigns being controlled, and internal bid generator determines bid values for multiple campaigns, and an internal auction module determines which internal bid is presented as the external bid 154 to the auction 150.

If the bid wins the auction, an advertising delivery service 160 (which may comprise multiple different servers, which may or may not be coordinated) presents advertising content to the user 180. Presentation of this content may provide opportunities to track data from the user based on their actions while advertising or other content is presented to the user. For example, navigation of subsequent web pages may be tracked by used of indicators that are transmitted to the advertising control system. One way this tracking may be accomplished is through embedding of references to pixels or beacons (e.g., reference to a 1×1 pixel transparent .gif file) which can provide information for tracking the user by the system.

Referring to FIG. 2, an example of a presentation of a web page 210 in a browser application on a client device includes an advertisement 220 presented in a region of the page. The advertisement includes creative content 220, which can include text, images, video, and audio, and also includes solicitations 224. As illustrated in FIG. 2, these solicitations can be visually embedded in conjunction with the creative content of the advertisement, or alternatively can be in a separate region of the advertisement, or in an associated region (e.g., a “popup” region). As introduced above, these solicitations can comprise survey questions to which the user responds by making a selection with a pointing device. Of course, in other examples of advertisements, other forms of responses are possible, for example, responding with a value (e.g., a numerical value) or a location in an image (e.g., a location on a map).

When the user provides the solicited response, that data is provided back to the advertising control system as discussed above with reference to FIG. 1. In some embodiments, when the user provides a response, the presentation of the advertisement is changed in accordance with the response. For example, an indication of liking a particular product may result in the advertisement providing further presentations about that product. Further solicitations of information within the same ad are also possible.

A variety of implementation approaches are used to cause the presentation of the advertisement with the embedded solicitation. Generally, an address or reference (e.g., a URL) for content of the advertisement is provided to the user's web browser application, which then retrieves the content. For example, the content includes multimedia data integrated together in a single unit that is delivered to the web browser that embeds both the creative content of the advertisement, as well as the solicitation and instructions or other specification of the software action to take at the user's device when the user responds. An example of the action to take when the user responds to the solicitation includes causing a request to be sent from the user's computer, for example, for further content (e.g., a pixel), which when received by the server computer to which the request is sent is used to identify the user and/or the instance of the presentation of the advertisement and the response by the user to the advertising control system. In other embodiments, other types of actions may be triggered by the user's response, causing at least some message to be sent from the user's computer in a way that directly or indirectly provides the user's response to the advertising system. An example of a single unit that integrates both the advertisement and the solicitation is a Flash Media (.swf) file, but a number of other data formats can also be used, for example, using HTML5.

In another implementation, the data provided to the browser for presenting the advertisement include a reference to a survey server for presentation of the solicitation, which is provided by the survey server for rendering over some portion of the advertisement. The user's response is then provided to the advertising control system either via the survey system or directly.

Both unsolicited data 162, for example, obtained by tracking the navigation of the user, and solicited data 164, for example, obtained in response to explicit solicitations, is stored as ad response data 170. The ad response data is used by the tracking component 120, for example, to update tracked parameters 130, which affect future bidding.

Various forms of automated tracking can be used to update the tracking parameters 130. For example, regression-based approaches, machine learning, non-parametric statistics, or expert systems may be used to determine tracking parameters 130 from the from the response data 170, which generally includes solicited data 164, from which target users can be identified and/or valued.

In some embodiments of the active advertising control system 110 that use regression-based approaches, the tracking parameters 130 include regression coefficient (e.g., coefficients for a logistic regression that is used to predict a probability of a desired response by the user). In some examples, solicited data forms an input to the regression, such that past solicited data affects the estimation of regression coefficients and past solicited data for a user for whom advertising is being considered is used in determining a bid value for the opportunity to present advertising to the user. In this way, the better the match of characteristics of a user in a new advertising opportunity to the characteristics of users who have self-identified themselves in their responses, the more likely the system will win the opportunity to present an advertisement to the new user.

Solicited data can also be combined with other data, including offline data, including without limitation proprietary customer data (e.g., income, purchase history, etc.), third-party behavioral data, and real-time ad response technology are used to predict who will respond to a brand's advertising. Approaches outlined above provide further data not available to conventions advertising targeting systems. In particular, solicited data can be used to directly or indirectly determine hard-to-predict psychographic data and consumer affinities. Such data can then be used to efficiently identify and engage hard-to-qualify consumers. As a result, a system that makes use of such solicited data can multiply the number of qualified prospects the campaign can reach, while at the same time minimizing wasted impressions and reducing cost per engagement.

In other embodiments, solicited data is used to determine a characterization of a desired group of users for other purposes. For example, advertising embedding surveys are used to acquire responses that are then used to identify other available characteristics for a target audience. In some examples, such characterizations may identify unexpected correlations, which can then be used extend an audience based on the inferred characteristics to target advertising, for example, using conventional techniques. For example, an unexpected affinity to a particular product may be correlated with a combination of liking a particular television network and liking dogs, a combination that may not have been expected by advertising analysts. Similarly, the automated approaches described above may be used in a fully or partially (e.g., assisting a human operator/analyst) automated manner in which the tracked parameters which characterize the optimized target audience can be used in a partial automation mode where a manual adjustment of the specific target group can be made.

In embodiments in which automated optimization of a target audience is used, it should be understood that various time scales for the feedback and optimization may be used. For example, characteristics of an optimized target audience based on the solicited data may be performed incrementally as data is received (e.g., in “real time”), or the data can be collected and the optimization performed in batches, for example, every 5 minutes, every hour, every 5 hours, etc.

In some embodiments, the approaches described above for embedded solicitations from users are combined with other forms of solicitation of data. For example, survey techniques that assess the overall effectiveness of an advertising campaign can be combined with the creative-embedded solicitations, for example, to correlate overall effectiveness with particular responses.

Implementations of the approaches described above make use of software, which is tangibly stored on computer-readable media. The software includes instructions for one or more data processing systems to perform the functions described above. This software also includes software for the advertising content with embedded solicitations, which includes instructions for execution of a user's client computer under the control of a browser application. The software also includes instructions for determining the tracked parameters of the target audience, which may execute on a different computer than other components of the system, such as the component that generates bids based on the parameters. It should also be understood that the computers that implement the overall advertising system are linked by data networks, for example, local area networks, and wide area public networks.

It is to be understood that the foregoing description is intended to illustrate and not to limit the scope of the invention, which is defined by the scope of the appended claims. Other embodiments are within the scope of the following claims.

1. A method for computer implemented control of electronic advertising comprising:
causing a plurality of instances of one or more electronic advertisements to be presented to a plurality of users at user devices, at least some of the instances of advertisements comprising embedded solicitations for information from the users to whom the advertisements are presented, each embedded solicitation including a solicitation to select one of a plurality of selectable answers to a question associated with the embedded solicitation, at least one selectable answer of the plurality of selectable answers being associated with a target characteristic of a desired group of users; and
receiving responses provided by a first set of the plurality users at the user device in response to presentations of the embedded solicitations, each of the responses including a selected answer to the question associated with the embedded solicitation;
wherein the causing of the instances of the advertisements to be presented includes automatically matching of the one or more advertisements and a second set of users belonging to the desired group using a computer implemented system according to the received responses provided by the first set of the users.

2. The computer implemented method of claim 1 wherein automatically matching the advertisements and second set of users includes determining a value for each of a plurality of opportunities to present advertisements to users, each opportunity being related to an advertisement and a user.

3. The computer implemented method of claim 2 wherein each opportunity is further related to a context for presenting the advertisement to the user.

4. The computer implemented method of claim 2 wherein causing the advertisements to be presented includes participating in an electronic advertising exchange according to the determined values for the opportunities.

5. (canceled)

6. The method of claim 1 wherein the embedded solicitations comprise embedded polls, and the responses comprise user responses to poll questions.

7. The method of claim 6 wherein presentations of the advertisements comprise visual integration of the polls in creative content of the advertisements.

8. The method of claim 1 further comprising:
maintaining, on a non-transitory computer readable storage medium coupled to a computer, data characterizing the plurality of users, said data comprising data representing the responses to the embedded solicitations presented to the first set of users; and
wherein automatically matching the users and advertisements according to the received responses includes at least one of (a) using the computer to compute a value for a first user for potential presentation of an advertisement and (b) using the computer to select advertisements for presentation in an advertising opportunity associated with a first user according to the data representing the solicitations presented to the plurality of users.

9. The method of claim 1 further comprising:
maintaining, on a non-transitory computer readable storage medium coupled to a computer, data characterizing the plurality of users, said data comprising data representing the responses to embedded solicitations presented in advertising opportunities to the users; and
processing the maintained data using a computer to characterize a target group of users selected according to responses to the embedded solicitations by said users.

10. The method of claim 1 wherein automatically matching according to the received responses comprises identifying the second set of the users using at least determined characteristics of a subset of the first set of the users selected according to responses to the embedded solicitations.

11. The method of claim 1 wherein automatically matching according to the received responses comprises valuing opportunities according to similarity of user characteristics of the opportunities to characteristics of a subset of the first set of the users selected according to responses to the embedded solicitations.

12. The method of claim 1 wherein automatically matching of advertisements and users comprises optimizing data characterizing a group of target users for presentation of an advertisement according to characteristics of a subset of the first set of the users selected according to responses to the embedded solicitations to achieve an objective defined in terms of the solicitations.

13. The method of claim 1 wherein presentations of the advertisements comprising embedded solicitations comprise solicitations that are visually integrated with advertising content of the advertisements.

14. The method of claim 1 wherein causing presentations of the advertisements comprising embedded solicitations comprises causing, for each instance of an advertisement, delivery of an integrated data unit comprising data representing the solicitation for that advertisement and data representing advertising content for visually integrated presentation.

15. The method of claim 14 wherein the integrated data unit further comprises content for conditional presentation according to user input.

16. The method of claim 1 wherein causing presentations of the advertisements comprising embedded solicitations comprises causing, for each instance of an advertisement, delivery of a data unit comprising a reference to an external source for data representing the solicitation for that advertisement for presentation in conjunction with advertising content of the advertisement.

17. A computer-readable medium tangibly embodying instructions for causing a data processing system to control of electronic advertising including instructions for causing the data processing system to:
cause a plurality of instances of one or more electronic advertisements to be presented to a plurality of users at user devices, at least some of the instances of advertisements comprising embedded solicitations for information from the users to whom the advertisements are presented, each embedded solicitation including a solicitation to select one of a plurality of selectable answers to a question associated with the embedded solicitation, at least one selectable answer of the plurality of selectable answers being associated with a target characteristic of a desired group of users; and
receive responses provided by a first set of the plurality users at the user device in response to presentations of the embedded solicitations, each of the responses including a selected answer to the question associated with the embedded solicitation;
wherein the causing of the instances of the advertisements to be presented includes automatically matching of the one or more advertisements and a second set of users belonging to the desired group using a computer implemented system according to the received responses provided by the first set of the users.

18. The software of claim 17 wherein automatically matching the advertisements and second set of users includes determining a value for each of a plurality of opportunities to present advertisements to users, each opportunity being related to an advertisement and a user.

19. The software of claim 17 wherein the instructions for causing a data processing system to control of electronic advertising further include instructions for causing the data processing system to:
maintain data characterizing the plurality of users, said data comprising data representing the responses to the embedded solicitations presented to the first set of users; and
wherein automatically matching the users and advertisements according to the received responses includes at least one of (a) valuing a first user for potential presentation of an advertisement and (b) selecting advertisements for presentation in an advertising opportunity associated with a first user according to the data representing the solicitations presented to the plurality of users.

20. A computer implemented advertising control system configured to:
cause a plurality of instances of one or more electronic advertisements to be presented to a plurality of users at user devices, at least some of the instances of advertisements comprising embedded solicitations for information from the users to whom the advertisements are presented, each embedded solicitation including a solicitation to select one of a plurality of selectable answers to a question associated with the embedded solicitation, at least one selectable answer of the plurality of selectable answers being associated with a target characteristic of a desired group of users; and
receive responses provided by a first set of the plurality users at the user device in response to presentations of the embedded solicitations, each of the responses including a selected answer to the question associated with the embedded solicitation;
wherein the causing of the instances of the advertisements to be presented includes automatically matching of the one or more advertisements and a second set of users belonging to the desired group using a computer implemented system according to the received responses provided by the first set of the users.

21. The method of claim 1 wherein automatically matching according to the received responses includes identifying the second set of the users including,
determining a subset of the first set of users according to the responses to the embedded solicitations including selecting users of the first set of users who selected the at least one selectable answer to the question,
comparing characteristics of the subset of the first set of users to characteristics of other users of the plurality of users; and
selecting users for inclusion in the second set of users based on the comparison.
